(19) United States
(12) Patent Application Publication
(10) Pub. No.: US 2011/0031758 A1
(43) Pub. Date: Feb. 10, 2011

(54) Reinforcing sheet for wind power generator blades, reinforcing structure of wind power generator blade, wind power generator, method for reinforcing the wind power generator blade

(75) Inventors: Yoshiaki Mitsuoka, Osaka (JP); Yasuhiko Kawaguchi, Osaka (JP); Takahiro Fujii, Osaka (JP); Takuji Okeyui, Osaka (JP)

Correspondence Address: AKERMAN SENTERFITT, 8100 BOONE BOULEVARD, SUITE 700, VIENNA, VA, 22182-2683, US

(73) Assignee: Nitto Denko Corporation, Osaka (JP)

(21) Appl. No.: 12/805,319

(22) Filed: Jul. 26, 2010

Related U.S. Application Data
(60) Provisional application No. 61/272,004, filed on Aug. 6, 2009.

(30) Foreign Application Priority Data
Aug. 5, 2009 (JP) JP2009-182402

(51) Int. Cl. F03D 9/00; B21K 3/04; F03B 3/12

(52) U.S. Cl. 290/55; 29/889.6; 416/240

(57) ABSTRACT

A reinforcing sheet for wind power generator blades includes a resin layer and a restricting layer laminated on the resin layer.

### CROSS REFERENCE TO RELATED APPLICATIONS

This application claims the benefit of U.S. Provisional Application No. 61/272,004, filed on Aug. 6, 2009, which claims priority from Japanese Patent Application No. 2009-182402, filed on Aug. 5, 2009, the contents of which are herein incorporated by reference in their entirety.

### BACKGROUND OF THE INVENTION

1. Field of the Invention

The present invention relates to a reinforcing sheet for wind power generator blades, a reinforcing structure of a wind power generator blade including the sheet, a wind power generator including the structure, and a method for reinforcing the wind power generator blade.

2. Description of Related Art

In recent years, wind power generators have been received much attention from the viewpoint of CO₂ reduction associated with global warming prevention. The wind power generator usually includes a support and a blade (vane) rotatably supported on the support, the blade rotating in response to wind forces, so that the rotational force thereof can generate electric power.

In the wind power generator, the rigidity capable of bearing wind forces is required for the blade. However, the higher the rigidity is, the more the weight of the blade increases. In particular, when further improved power generation efficiency is desired, it is necessary to upsize the blade in order to be efficiently exposed to wind forces. In such case, the weight of the blade further increases to secure further rigidity.

Then, along with such increased weight, power generation efficiency deteriorates. Therefore, the blade is required to have high rigidity and light weight.

From the above viewpoints, there has been proposed, for example, a windmill blade which is composed of an outer cover layer made of carbon fiber reinforced plastic, a main strength material integrally molded therewith, and a girder member positioned in the inner side of the main strength material (cf. Japanese Unexamined Patent Publication No. 2007-255366). With the windmill blade disclosed in Japanese Unexamined Patent Publication No. 2007-255366, a main strength material is arranged on the ventral side and on the back side of the windmill blade so as to be spaced apart from each other, and these main strength materials are coupled in a generally H-shape in cross section with the grinder members, thereby improving the strength of the windmill blade.

Further, there has been proposed a wind power generator blade which is composed of a skin layer made of reinforced resin, and a reinforcing material and a main girder both covered with the skin layer (cf. Japanese Unexamined Patent Publication No. 2007-9926). The wind power generator blade disclosed in Japanese Unexamined Patent Publication No. 2007-9926 is produced in the following manner. A reinforcing tape and a reinforcing cloth made of reinforcing fiber is sequentially wound around a core material, and subsequently, they are impregnated with resin to be preimpregnated, so that the main girder having hollow space of slot-like shape in cross section is formed. Next, a reinforcing material is arranged on both lengthwise sides of the main girder, and the skin layer then collectively covers them to thereby produce the wind power generator blade. The wind power generator blade has improved strength with the main girder arranged in the center.

### SUMMARY OF THE INVENTION

The arrangement of the main strength material or the girder member of Japanese Unexamined Patent Publication No. 2007-255366, or the arrangement of the main girder of Japanese Unexamined Patent Publication No. 2007-9926, however, has already been determined in the wind power generator blade (windmill blade) at the design stage, so that such member is naturally arranged in the predetermined position in the production process of the wind power generator blade.

On the other hand, after the outer cover layer or the skin layer are formed, a portion desired to be reinforced may further develop therein. However, the main strength material of Japanese Unexamined Patent Publication No. 2007-255366 is integrally molded simultaneously with the outer cover layer, and the main girder disclosed in Japanese Unexamined Patent Publication No. 2007-9926 has already formed before formation of the skin layer. Therefore, the above-mentioned portion cannot be reinforced due to these main strength material and main girder.

It is an object of the present invention to provide a reinforcing sheet for wind power generator blades, capable of easily and sufficiently reinforcing any point in a wind power generator blade and also capable of securing light weight, a reinforcement structure of a wind power generator blade, a wind power generator, and a method for reinforcing the wind power generator blade.

The reinforcing sheet for wind power generator blades of the present invention includes a resin layer and a restricting layer laminated on the resin layer.

In the reinforcing sheet for wind power generator blades of the present invention, it is preferable that the resin layer is made of a thermosetting resin.

In the reinforcing sheet for wind power generator blades of the present invention, it is preferable that the resin layer contains an epoxy resin.

In the reinforcing sheet for wind power generator blades of the present invention, it is preferable that the resin layer further contains a synthetic rubber, and that the synthetic rubber contains styrene synthetic rubber and/or acrylonitrile-butadiene rubber.

In the reinforcing sheet for wind power generator blades of the present invention, it is preferable that the resin layer contains a foaming agent and is formable.

In the reinforcing sheet for wind power generator blades of the present invention, it is preferable that the resin layer is formed of a thermally adhering type adhesive composition, that the adhesive composition contains a polymer derived from monomers containing conjugated dienes, and that the adhesive composition further contains a tackifier.

In the reinforcing sheet for wind power generator blades of the present invention, it is preferable that the restricting layer is a glass cloth and/or a metal sheet.

In the reinforcement structure of the wind power generator blade, the above-mentioned reinforcing sheet for wind power generator blades is adhesively bonded to an inner side surface of a wind power generator blade having a hollow structure.

The wind power generator of the present invention has the reinforcement structure of the wind power generator blade as described above.

The method for reinforcing the wind power generator blade includes the step s of: preparing a reinforcing sheet for wind power generator blades comprising a resin layer and a restricting layer laminated on the resin layer; and adhesively bonding the reinforcing sheet for wind power generator blades to an inner side surface of a wind power generator blade having a hollow structure.

The method for reinforcing the wind power generator blade includes the steps of adhesively bonding the above-mentioned reinforcing sheet for wind power generator blades to an inner side surface of a wind power generator blade having a hollow structure; and heating the reinforcing sheet for wind power generator blades.

The method for reinforcing the wind power generator blade includes the steps of preliminarily heating the above-mentioned reinforcing sheet for wind power generator blades; and adhesively bonding the heated reinforcing sheet for wind power generator blades to an inner side surface of a wind power generator blade having a hollow structure.

According to the reinforcing sheet for wind power generator blades, the reinforcement structure of the wind power generator blade, the wind power generator, and the method for reinforcing the wind power generator blade of the present invention, the reinforcing sheet for wind power generator blades is arranged in any point in the wind power generator blade to easily and sufficiently reinforce the wind power generator blade, so that the rigidity of the wind power generator blade can be easily and reliably secured, and the light weight of the wind power generator blade can be secured.

### BRIEF DESCRIPTION OF THE DRAWINGS

FIG. 1 is a sectional view showing one embodiment of a reinforcing sheet for wind power generator blades according to the present invention;

FIG. 2 is a front view showing one embodiment of a wind power generator according to the present invention;

FIG. 3 is a sectional view showing one embodiment of a reinforcement structure of and a reinforcing method for a wind power generator blade according to the present invention, which taken along the line A-A of FIG. 2,

(a) showing the step of adhesively bonding a reinforcing sheet for wind power generator blades to a wind power generator blade, and

(b) showing the step of heating the reinforcing sheet for wind power generator blades to foam a resin layer, and

(c) showing the step of heating the reinforcing sheet for wind power generator blades to cure/thermally adhere the resin layer;

FIG. 4 is a sectional view of another embodiment (embodiment in which a reinforcing sheet for wind power generator blades is adhesively bonded to both ends in a rotation direction of a wind power generator blade) of the reinforcement structure of and the reinforcing method for the wind power generator blade according to the present invention;

FIG. 5 is a sectional view of another embodiment (embodiment in which a reinforcing sheet for wind power generator blades is adhesively bonded to a connecting portion between a skin and a girder of a wind power generator blade) of the reinforcement structure of and the reinforcing method for the wind power generator blade according to the present invention; and

FIG. 6 is a sectional view of another embodiment (embodiment in which a reinforcing sheet for wind power generator blades is adhesively bonded to both radial ends of a wind power generator blade) of the reinforcement structure of and the reinforcing method for the wind power generator blade according to the present invention.

### DETAILED DESCRIPTION OF PREFERRED EMBODIMENTS

The reinforcing sheet for wind power generator blades of the present invention includes a resin layer and a restricting layer laminated on the resin layer.

The resin layer is formed by molding a resin composition in a sheet form.

The resin composition is not particularly limited as long as it contains at least a resin component. The resin composition optionally contains a curing agent, a crosslinking agent, a foaming agent, and a tackifier depending upon the kind of the resin component.

The resin component is not particularly limited, and examples thereof include thermosetting resin and thermoplastic resin. Preferably, a thermosetting resin is used.

The thermosetting resin is not particularly limited and examples thereof include epoxy resin, acrylic resin, and synthetic rubber.

The epoxy resin is not particularly limited, and examples thereof include aromatic epoxy resin, aliphatic and alicyclic epoxy resin, and ring containing nitrogen epoxy resin.

The aromatic epoxy resin is an epoxy resin containing a benzene ring as a constitutional unit in a molecular chain. The aromatic epoxy resin is not particularly limited and examples thereof include bisphenol epoxy resin such as bisphenol A type epoxy resin, dimer acid modified bisphenol A type epoxy resin, bisphenol F type epoxy resin and bisphenol S type epoxy resin; novolak epoxy resin such as phenol novolak epoxy resin and cresol novolak epoxy resin; naphthalene epoxy resin; and biphenyl epoxy resin.

Examples of the aliphatic and alicyclic epoxy resin include hydrogenated bisphenol A type epoxy resin, dicyclo type epoxy resin and alicyclic epoxy resin.

Examples of the ring containing nitrogen epoxy resin include triglycidyl isocyanurate epoxy resin and hydantoin epoxy resin.

These epoxy resins may be used alone or in combination. Of these epoxy resins, aromatic epoxy resin, and aliphatic and alicyclic epoxy resin are preferably used, and bisphenol epoxy resin and alicyclic epoxy resin are more preferably used, in terms of reinforcement.

Epoxy equivalent of such epoxy resin is preferably in the range of 150 to 350 g/eq., for example, when the resin layer is formable; or preferably 450 to 1000 g/eq., for example, when the resin layer is curable.

The acrylic resin is obtained by polymerization of a monomer component which predominantly contains alkyl(meth)acrylate.

Examples of the alkyl(meth)acrylates include alkyl (meth)acrylate (with a linear or branched alkyl moiety having 1 to 20 carbon atoms) such as butyl (meth)acrylate, hexyl(meth)acrylate, 2-ethylhexyl (meth)acrylate, and nonyl(meth)acrylate. These (meth)acrylates can be used alone or in combination of two or more kinds.

The monomer components can optionally contain a polar group-containing vinyl monomer or a polyfunctional vinyl monomer as well as essentially containing the above-mentioned alkyl(meth)acrylate.

Examples of the polar group-containing vinyl monomer include carboxyl group-containing vinyl monomers or anhydride thereof (such as maleic anhydride); and hydroxyl group-containing vinyl monomers such as hydroxyethyl (meth)acrylate.

Examples of the polyfunctional vinyl monomer include (mono or poly)ethylene glycol di(meth)acrylates such as ethylene glycol di(meth)acrylate; and (meth)acrylate monomer of a polyhydric alcohol such as 1,6-hexandiol di(meth)acrylate.

As for the amount of the monomer components, for example, in the monomer components, the amount of the polar group-containing vinyl monomer is, for example, 30% by weight or less, the amount of the polyfunctional vinyl monomer is, for example, 2% by weight or less, and the amount of the alkyl(meth)acrylate is the remainder thereof.

The synthetic rubber is preferably used in combination with the epoxy resin. The synthetic rubber is not particularly limited and, for example, styrene synthetic rubber or acrylonitrile-butadiene rubber (NBR: acrylonitrile butadiene copolymer) is preferably used.

The styrene synthetic rubber is synthetic rubber in which at least styrene is blended as a raw material monomer. The styrene synthetic rubber is not particularly limited, and examples thereof include styrene-butadiene rubber such as styrene-butadiene random copolymer, styrene-butadiene-styrene block copolymer (SBS), styrene-ethylene-butadiene copolymer, and styrene-ethylene-butadiene-styrene block copolymer; and styrene-isoprene rubber such as styrene-isoprene-styrene block copolymer (SIS).

These may be used alone or in combination. Of these styrene synthetic rubbers, styrene-butadiene rubber is preferably used in terms of reinforcement and adhesion.

The styrene synthetic rubber contains preferably not more than 50% by weight of styrene, or more preferably not more than 35% by weight of styrene. The styrene content of more than this may induce reduction of adhesion under low temperature.

The number average molecular weight of the styrene synthetic rubber is not less than 30,000, or preferably ranges from 50,000 to 1,000,000. The number average molecular weight of less than 30,000 may induce reduction of adhesion.

Also, the Mooney viscosity (ML1+4, at 100° C.) of the styrene synthetic rubber is in the range of, for example, 20 to 60, or preferably 30 to 50.

The amount of the styrene synthetic rubber is in the range of, for example, 30 to 70 parts by weight, or preferably 40 to 60 parts by weight, per 100 parts by weight of the resin component. The amount of the styrene synthetic rubber of less than this may induce reduction of adhesion. On the other hand, the amount of the styrene synthetic rubber of more than this may induce reduction of reinforcement.

When the styrene synthetic rubber is blended as the synthetic rubber, an epoxy-modified styrene synthetic rubber can be used in combination as the synthetic rubber. The use of the epoxy-modified styrene synthetic rubber in combination can provide improved compatibility of the styrene synthetic rubber with an epoxy resin, particularly an aromatic epoxy resin, thereby achieving further improved adhesion and reinforcement.

The epoxy-modified styrene synthetic rubber is synthetic rubber produced by modifying the above-mentioned styrene synthetic rubber at an end of molecular chain or in a molecular chain thereof with an epoxy group. Epoxy equivalent of the epoxy-modified styrene synthetic rubber preferably used is in the range of, for example, 100 to 10,000 g/eq., or preferably 400 to 3,000 g/eq.

The styrene synthetic rubber can be modified with an epoxy group by a known method. For example, an epoxidizing agent such as peracids and hydroperoxides is allowed to react with a double bond in the styrene synthetic rubber in an inert solvent.

Examples of the epoxy-modified styrene synthetic rubber include epoxy-modified styrene-butadiene-styrene block copolymer, epoxy-modified styrene-ethylene-butadiene-styrene block copolymer, and epoxy-modified styrene-isoprene-styrene block copolymer.

These may be used alone or in combination. Of these epoxy-modified styrene synthetic rubbers, epoxy-modified styrene-butadiene-styrene block copolymer is preferably used in terms of satisfying both the reinforcement and the adhesiveness.

The amount of the epoxy-modified styrene synthetic rubber is in the range of, for example, 1 to 20 parts by weight, or preferably 5 to 15 parts by weight, per 100 parts by weight of the resin component. The amount of the epoxy-modified styrene synthetic rubber of less than this may induce reduction of reinforcement and adhesion. On the other hand, the amount of the epoxy-modified styrene synthetic rubber of more than this may induce reduction of adhesion under low temperature.

The acrylonitrile-butadiene rubber is synthetic rubber obtained by copolymerizing acrylonitrile and butadiene. The acrylonitrile-butadiene rubber is not particularly limited and includes, for example, acrylonitrile-butadiene rubber in which a carboxyl group is introduced, and acrylonitrile-butadiene rubber partially crosslinked with sulfur or metal oxide. The acrylonitrile-butadiene rubber is solid rubber and has excellent compatibility with an epoxy resin. Therefore, the containing of the acrylonitrile-butadiene rubber can provide improved adhesiveness and handleability, and further improved reinforcement in a wide temperature range around room temperature (23° C.).

The acrylonitrile-butadiene rubber contains acrylonitrile preferably in the range of 10 to 50% by weight, and the Mooney viscosity thereof is preferably not less than 25 (ML1+4, at 100° C.).

The amount of the acrylonitrile-butadiene rubber is in the range of, for example, 5 to 30 parts by weight, or preferably 8 to 25 parts by weight, per 100 parts by weight of the resin component. The amount of the acrylonitrile-butadiene rubber of less than this may induce reduction of reinforcing effect. On the other hand, the amount of the acrylonitrile-butadiene rubber of more than this may induce excessively low viscosity of the resin composition, which leads to poor handleability. On the contrary, the amount thereof within the above range can develop low-temperature adhesiveness resulting from excellent compatibility with epoxy resin and high-temperature coherence resulting from acrylonitrile-butadiene rubber being solid rubber, thereby achieving excellent handleability and reinforcing effect.

Further, low polar rubber may be used as synthetic rubber. The containing of low polar rubber may achieve further improved adhesion. The low polar rubber is a rubber that does not contain polar group such as an amino group, a carboxyl group and a nitrile group. Examples of the low polar rubber include solid or liquid synthetic rubber such as butadiene rubber, polybutene rubber, and synthetic natural rubber. The low polar rubber also includes the above-mentioned styrene-butadiene rubber. These may be used alone or in combination. The low polar rubber is preferably used in combination with acrylonitrile-butadiene rubber, and the amount of the low polar rubber is in the range of, for example, 1 to 70 parts by weight, or preferably 5 to 50 parts by weight, per 100 parts by weight of the resin component.

In addition to the above rubbers, examples of the synthetic rubber include butadiene rubber, isoprene rubber, chloroprene rubber, polyisobutylene rubber, polyisobutene rubber, polybutene rubber, and isobutylene-isoprene rubber.

The thermoplastic resins that may be used include, for example, ethylene copolymer and conjugated diene polymer from the viewpoint of heat sealing (thermal adhesion) of the resin layer within a low temperature range (e.g., 30 to 120° C.).

The ethylene copolymer is a resin made of a copolymer of ethylene with a monomer copolymerizable with ethylene. Examples of the ethylene copolymer include ethylene-vinyl acetate copolymer (EVA) and ethylene-alkyl(meth)acrylate copolymer.

The ethylene-vinyl acetate copolymer is, for example, a random or block copolymer of ethylene and vinyl acetate, or preferably a random copolymer thereof.

The ethylene-vinyl acetate copolymer contains vinyl acetate in the range of, for example, 12 to 50% by weight, or preferably 14 to 46% by weight (in conformity with the MDP method, the same applies to the following); and has a melt flow rate (MFR; in conformity with JIS K6730; hereinafter simply referred to as MFR) of, for example, 1 to 30 g/10 min., or preferably 1 to 15 g/10 min.; a hardness (JIS K₇₂₁₅) of, for example, 60 to 100 degrees, or preferably 70 to 100 degrees; a softening temperature of, for example, 35 to 70° C.; and a melting point of, for example, 70 to 100° C.

The ethylene-alkyl(meth)acrylate copolymer is, for example, a random or block copolymer of ethylene and alkyl(meth)acrylate, or preferably a random copolymer thereof.

The alkyl(meth)acrylate is alkyl methacrylate and/or alkyl acrylate, and more specifically, examples thereof include alkyl (meth)acrylate (with a linear or branched alkyl moiety having 1 to 18 carbon atoms) such as methyl (meth)acrylate, ethyl (meth)acrylate, propyl (meth)acrylate, and isopropyl (meth)acrylate, butyl (meth)acrylate, isobutyl (meth)acrylate, sec-butyl(meth)acrylate, t-butyl (meth)acrylate, pentyl (meth)acrylate, neopentyl (meth)acrylate, isopentyl (meth)acrylate, hexyl(meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, and octadecyl (meth)acrylate. These alkyl (meth)acrylates) can be used alone or in combination.

Ethylene-ethyl acrylate copolymer (EEA) and ethylene-butyl acrylate copolymer (EBA) are preferably used.

The ethylene-ethyl acrylate copolymer contains ethyl acrylate in the range of, for example, 9 to 35% by mass, or preferably 9 to 25% by mass (EA content, MDP method); and has a MFR of, for example, 0.5 to 25 g/10 min., or preferably 0.5 to 20 g/10 min.; a hardness (Shore A, JIS K7215 (1986)) of, for example, 60 to 100 degrees, or preferably 70 to 100 degrees; a softening temperature (BiCat, JIS K7206 (1999)) of, for example, 35 to 70° C.; a melting point (JIS K7121 (1987)) of, for example, 70 to 100° C.; and a glass transition temperature (DVE method) of, for example, −40° C. to −20° C.

The ethylene-butyl acrylate copolymer contains butyl acrylate in the range of, for example, 7 to 35% by mass, or preferably 15 to 30% by mass (EB content, DuPont method); and has a MFR of, for example, 1 to 6 g/10 min., or preferably 1 to 4 g/10 min.; a hardness (Shore A, ISO 868 or JIS K7215) of, for example, 75 to 100 degrees, or preferably 80 to 95 degrees; a softening temperature (BiCat, softening point, JIS K7206 or ISO 306) of, for example, 35 to 70° C., or preferably 40 to 65° C.; and a melting point (JIS K7121 or ISO 3146) of, for example, 80 to 120° C., or preferably 90 to 100° C.

When the resin component contains an ethylene copolymer, the melting point of the resin composition can be set in the range of, for example, 60 to 120° C., or preferably 70 to 100° C., and the resin layer can be heat-sealed within this temperature range (at low temperature). The above temperature range is set lower than the curing temperature, i.e., the temperature at which the curing agent decomposes (e.g., from 150 to 200° C.) when the resin component is thermosetting resin.

The conjugated diene polymer is a polymer derived from monomers which predominantly contain conjugated dienes.

Examples of the conjugated dienes include 1,3-butadiene, isoprene (2-methyl-1,3-butadiene), and chloroprene (2-chloro-1,3-butadiene).

The monomer can essentially contain conjugated dienes and optionally contain a copolymeric monomer copolymerizable with the conjugated dienes.

Examples of the copolymeric monomer include nonconjugated dienes such as 1,2-butadiene; olefins such as ethylene, propylene, and isobutylene (2-methylpropene); aromatic vinyl monomers such as styrene; and cyano group-containing vinyl monomers such as (meth)acrylonitrile.

These copolymeric monomers can be used alone or in combination of two or more kinds.

Specifically, the above-mentioned styrene synthetic rubber or NBR can be included as the conjugated diene polymer. To be more specific, examples thereof include homopolymers of the monomers only containing the above-mentioned essential components, such as polybutadiene, polyisoprene, and chloroprene polymer (CR); and copolymers of the monomers containing the above-mentioned essential components and the optional components, such as acrylonitrile-butadiene (random) copolymer, styrene-butadiene-styrene (block) copolymer (SBS), styrene-butadiene (random) copolymer, styrene-isoprene-styrene (block) copolymer (SIS), isobutylene-isoprene (random) copolymer, styrene-ethylene-styrene (block) copolymer (SES), and styrene-ethylene-butylene-styrene (block) copolymer (SEBS).

When the conjugated diene polymer is the above-mentioned copolymer, the amount of the copolymeric monomer in copolymerization is in the range of, for example, 10 to 100 parts by weight per 100 parts by weight of the conjugated dienes.

The weight average molecular weight (measured by GPC in terms of polystylene) of the conjugated diene polymer is, for example, 20,000 or more, or preferably from 25,000 to 100,000.

Also, the Mooney viscosity of the conjugated diene polymer is in the range of, for example, 20 to 80 (ML1+4, at 100° C.), or preferably 30 to 70 (ML1+4, at 100° C.).

The conjugated diene polymer has a 25 weight percent toluene solution viscosity (at 25° C.) of, for example, 100 to 100,000 mPa·s, or preferably 500 to 10,000 mPa·s.

The conjugated diene polymer has a MFR (at a temperature of 190° C. and a weight of 2.16 kg) of, for example, 10 g/10 min. or less, or a MFR (a temperature of 200° C. and a weight of 5 kg) of, for example, 20 g/10 min. or less.

These conjugated diene polymers can be used alone or in combination of two or more kinds.

Of these conjugated diene polymers, CR and SBS are preferable, or SBS is more preferable.

When the resin component contains a conjugated diene polymer, the melting point of the resin composition can be set in the range of, for example, 60 to 170° C., or preferably 70 to 150° C. This can set the heat sealing (thermal adhesion) temperature to 80° C. or higher, preferably 90° C. or higher, or more preferably 100° C. or higher, and usually a heat resistant temperature of the wind power generator blade or lower. Specifically, it can be set in the temperature range (low temperature) of 130° C. or lower, preferably 30 to 120° C., or more preferably 80 to 110° C.

When the resin layer is cured, and further when the resin layer is foamed, thermosetting resin is selected as the resin component, and more specifically, one kind or two or more kinds of resin is/are selected from the above-mentioned epoxy resins, acrylic resins, and synthetic rubbers. Preferably, epoxy resin is selected as an essential component, and acrylic resin or synthetic rubber is selected as an optional component. More preferably, both the epoxy resin and the synthetic rubber are selected. Even more preferably, for example, the combination use of epoxy resin and styrene synthetic rubber, the combination use of epoxy resin and acrylonitrile-butadiene rubber, or the combination use of epoxy resin and low polar rubber is selected.

When the resin layer is heat-sealed (thermally adhered), thermoplastic resin is selected as the resin component, or preferably ethylene copolymer or conjugated diene polymer is selected. In this case, the resin composition is provided as a thermally adhering type adhesive composition.

The curing agent is blended, for example, when the resin component contains thermosetting resin such as epoxy resin. The curing agents that may be blended includes, for example, amine compounds, acid anhydride compounds, amide compounds, hydrazide compounds, imidazole compounds, and imidazoline compounds. In addition to these, phenol compounds, urea compounds, and polysulfide compounds can be blended as the curing agent.

Examples of the amine compounds include ethylenediamine, propylenediamine, diethylenetriamine, triethylenetetramine, amine adducts thereof, metaphenylenediamine, diaminodiphenylmethane, and diaminodiphenylsulfone.

Examples of the acid anhydride compound include phthalic anhydride, maleic anhydride, tetrahydrophthalic anhydride, hexahydrophthalic anhydride, methyl nadic anhydride, pyromellitic anhydride, dodecenylsuccinic anhydride, dichlorosuccinic anhydride, benzophenonetetracarboxylic anhydride, and chlorendic anhydride.

Examples of the amide compound include dicyandiamide and polyamide.

Examples of the hydrazide compound include dihydrazide such as adipic dihydrazide.

Examples of the imidazole compound include methyl imidazole, 2-ethyl-4-methyl imidazole, ethyl imidazole, isopropyl imidazole, 2,4-dimethylimidazole, phenylimidazole, undecylimidazole, heptadecylimidazole, and 2-phenyl-4-methylimidazole.

Examples of the imidazoline compound include methylimidazoline, 2-ethyl-4-methylimidazoline, ethylimidazoline, isopropylimidazoline, 2,4-dimethylimidazoline, phenylimidazoline, undecylimidazoline, heptadecylimidazoline, and 2-phenyl-4-methyl imidazoline.

These curing agents may be used alone or in combination. Of these curing agents, dicyandiamide is preferably used in terms of adhesion.

The amount of the curing agent is in the range of, for example, 0.5 to 50 parts by weight, preferably 1 to 40 parts by weight, or more preferably 1 to 15 parts by weight, per 100 parts by weight of the resin component, depending upon the equivalent ratio of the curing agent to the resin component.

If desired, a curing accelerator can be used in combination with the curing agent. Examples of the curing accelerator include tertiary amines, phosphorus compounds, quaternary ammonium salts, and organic metal salts. These may be used alone or in combination. The amount of the curing accelerator is in the range of, for example, 0.1 to 20 parts by weight, or preferably 0.2 to 10 parts by weight, per 100 parts by weight of the resin component.

The crosslinking agent is blended, for example, when the resin component contains a crosslinking resin such as synthetic rubber. Examples of the crosslinking agent include sulfur, sulfur compounds, selenium, magnesium oxide, lead monoxide, organic peroxides (e.g., dicumyl peroxide, 1,1-ditert-butyl-peroxy-3,3,5-trimethylcyclohexane, 2,5-dimethyl-2,5-ditert-butyl-peroxyhexane, 2,5-dimethyl-2,5-ditert-butyl-peroxyhexyne, 1,3-bis(tert-butyl-peroxyisopropyl)benzene, tert-butyl-peroxyketone, and tert-butyl-peroxybenzoate), polyamines, oximes (e.g., p-quinone dioxime and p,p′-dibenzoyl quinone dioxime, etc.), nitroso compounds (e.g., p-dinitroso benzine, etc.), resins (e.g., alkyl phenol-formaldehyde resin, melamine-formaldehyde condensate, etc.), and ammonium salts (e.g., ammonium benzoate, etc.).

These crosslinking agents may be used alone or in combination. Of these crosslinking agents, sulfur is preferably used in terms of the curing properties and the reinforcement.

The amount of the crosslinking agent is in the range of, for example, 1 to 20 parts by weight, or preferably 2 to 15 parts by weight, per 100 parts by weight of the resin component. The amount of the crosslinking agent of less than this may induce reduction in reinforcement. On the other hand, the amount of the crosslinking agent of more than this may induce reduction in adhesion and may induce cost-defectiveness.

If desired, a crosslinking accelerator can be used in combination with the crosslinking agent. Examples of the crosslinking accelerator include zinc oxide, disulfides, dithiocarbamic acids, thiazoles, guanidines, sulfenamides, thiurams, xanthogenic acids, aldehyde ammonias, aldehyde amines, and thioureas. These crosslinking accelerators may be used alone or in combination. The amount of the crosslinking accelerator is in the range of, for example, 1 to 20 parts by weight, or preferably 3 to 15 parts by weight, per 100 parts by weight of the resin component.

The foaming agent is blended, for example, when the resin layer is desired to be foamed. The foaming agents that may be blended include, for example, an inorganic foaming agent and an organic foaming agent. Examples of the inorganic foaming agent include ammonium carbonate, ammonium hydrogen carbonate, sodium hydrogen carbonate, ammonium nitrite, sodium borohydride, and azides.

The organic foaming agents that may be used include, for example, an N-nitroso compound (N,N′-dinitrosopentamethylenetetramine, N,N′-dimethyl-N,N′-dinitrosoterephthalamide, etc.), an azoic compound (e.g., azobis (isobutyronitrile), azodicarboxylic amide, barium azodicarboxylate, etc.), alkane fluoride (e.g., trichloromonofluoromethane, dichloromonofluoromethane, etc.), a hydrazine compound (e.g., paratoluene sulfonyl hydrazide, diphenylsulfone-3,3′-disulfonyl hydrazide, 4,4′-oxybis (benzene sulfonyl hydrazide), allylbis (sulfonyl hydrazide), etc.), a semicarbazide compound (e.g., p-toluoylenesulfonyl semicarbazide, 4,4′-oxybis(benzene sulfonyl semicarbazide, etc.), and a triazole compound (e.g., 5-morphoryl-1,2,3,4-thiatriazole, etc.).

The foaming agents may be in the form of thermally expansible microparticles comprising microcapsules formed by encapsulating thermally expansive material (e.g., isobutane, pentane, etc.) in a microcapsule (e.g., microcapsule of thermoplastic resin such as vinylidene chloride, acrylonitrile, acrylic ester, and methacrylic ester). Commercially available products such as Microsphere (product name; manufactured by Matsumoto Yushi-Seiyaku Co., Ltd.), may be used as the thermally expansible microparticles.

These foaming agents may be used alone or in combination. Of these foaming agents, 4,4′-oxybis (benzene sulfonyl hydrazide) (OBSH) is preferably used in terms of less susceptible to external factors and foaming stability.

The amount of the foaming agent is in the range of 0.1 to 30 parts by weight, or preferably 0.5 to 20 parts by weight, per 100 parts by weight of the resin component. The amount of the foaming agent of less than this may induce insufficient foaming, so that it causes reduction in thickness and thus in reinforcement. On the other hand, the amount of the foaming agent of more than this may induce reduction in density and thus in reinforcement.

If desired, a foaming auxiliary agent can be used in combination with the foaming agent. Examples of the foaming auxiliary agent include zinc stearate, a urea compound, a salicylic compound, and a benzoic compound. These foaming auxiliary agents may be used alone or in combination. The amount of the foaming auxiliary agent is in the range of, for example, 0.1 to 10 parts by weight, or preferably 0.2 to 5 parts by weight, per 100 parts by weight of the resin component.

The tackifier is blended with a resin composition in order to improve the adhesion of the resin layer to the wind power generator blade and the restricting layer or to improve the reinforcing properties of the wind power generator blade during reinforcement.

The tackifier is preferably blended when the resin composition contains a thermoplastic resin (preferably a conjugated diene polymer).

Examples of the tackifier include rosin resin, terpene resin, cumarone-indene resin (cumarone resin), and petroleum resin (e.g., alicyclic petroleum resin, aliphatic/aromatic copolymeric petroleum resin, and aromatic petroleum resin; and e.g., C5/C6 petroleum resin, C5 petroleum resin, C9 petroleum resin, and C5/C9 petroleum resin), and phenol resin (e.g., terpene-modified phenol resin, etc.).

The tackifier has a softening point of, for example, 50 to 150° C., or preferably 50 to 130° C.

These tackifiers can be used alone or in combination of two or more kinds.

The amount of the tackifier is in the range of, for example, 1 to 200 parts by weight, or preferably 5 to 150 parts by weight, per 100 parts by weight of the resin component. In addition, the amount of the tackifier is in the range of, for example, 40 to 200 parts by weight, or preferably 50 to 170 parts by weight, per 100 parts by weight of the polymer.

When the amount of the tackifier is less than the above range, the adhesion of the resin layer to the wind power generator blade and the restricting layer may not sufficiently be improved, or the reinforcing properties of the wind power generator blade during reinforcement may not sufficiently be improved. On the other hand, when the amount of the tackifier exceeds the above range, the resin layer may become brittle.

In addition to these components described above, a filler and an antiaging agent may be contained in the resin composition. Further, if desired, known additives such as a thixotropic agent (e.g., montmorillonite, etc.), lubricant (e.g., stearic acid, etc.), pigment, an antiscorching agent, a stabilizer, a softening agent, a plasticizer, an antioxidant, an ultraviolet absorber, a coloring agent, a mildewproofing agent, and a flame retardant can also be appropriately contained in the resin composition.

Examples of the filler include magnesium oxide, calcium carbonate (e.g., calcium carbonate heavy, calcium carbonate light, Hakuenka (R) (colloidal calcium carbonate), etc.), talc, mica, clay, mica powder, bentonite (e.g., organic bentonite), silica, alumina, aluminium hydroxide, aluminium silicate, titanium oxide, carbon black (e.g., insulating carbon black, acetylene black, etc.), aluminium powder, and glass balloon. These fillers can be used alone or in combination of two or more kinds. In particular, the use of a hollow filler having a low specific gravity such as glass baloon allows reduction in the weight of the resin layer without using any foaming agent.

When the resin composition contains a thermoplastic resin, specifically, an ethylene copolymer, it is preferable that the filler and the tackifier are blended.

Examples of the antiaging agent include amine-ketone-containing antiaging agent, aromatic secondary amine-containing antiaging agent, phenol-containing antiaging agent, benzimidazole-containing antiaging agent (e.g., 2-mercaptobenzimidazole, etc.), thiourea-containing antiaging agent, and phosphorous acid-containing antiaging agent. These antiaging agents can be used alone or in combination of two or more kinds.

The amount of the additive, particularly, the amount of the filler is in the range of, for example, 1 to 200 parts by weight per 100 parts by weight of the resin component, and the amount of the antiaging agent is in the range of, for example, 0.1 to 5 parts by weight, per 100 parts by weight of the resin component.

When the resin composition contains a thermosetting resin and a curing agent, the resin layer can be a curable resin layer. When the resin composition contains a thermosetting resin, a curing agent, and a foaming agent, the resin layer can be a formable resin layer. When the resin composition contains a thermoplastic resin (and does not contain a thermosetting resin, a curing agent, and a foaming agent), the resin layer can be a heat-sealable (thermally adherable) resin layer.

The resin composition can be prepared by blending the above-mentioned components in the above-mentioned amounts. In order to form a resin layer and then laminate the resin layer on a restricting layer, the following process (direct formation process) may be used. The above-mentioned amounts of the components described above are dissolved or dispersed in a known solvent (e.g., toluene, etc.) or in water to prepare a solution or a dispersion. Thereafter, the solution or dispersion thus prepared is applied onto a surface of the restricting layer, and then dried.

Alternatively, the following process (transferring process) may be used. The solution or dispersion thus prepared is applied onto a surface of a release film to be described later, and then dried to form a resin layer. Subsequently, the resin layer is transferred onto a surface of a restricting layer.

The above-mentioned solution or dispersion has a viscosity (measured value at 30° C. using a B type viscometer) of, for example, 5 to 20 Pa·s.

In addition, in order to prepare a resin composition to form a resin layer and then laminate the resin layer on a restricting layer, the following process (direct formation process) may be used. The above-mentioned components (except the above-mentioned solvent and water) are directly kneaded, for example, with a mixing roll, a pressure kneader, or an extruder, to prepare a kneaded material. Thereafter, the kneaded material thus prepared is molded (rolled) into a sheet form, for example, by calendaring, extrusion, or press molding to thereby form a resin layer. The resin layer is then laminated on a surface of a restricting layer. Alternatively, the following process (transferring process) may be used. The resin layer thus formed is laminated on a surface of a release film, and then transferred onto a surface of a restricting layer.

The kneaded material described above has a flow tester viscosity (60° C., 24 kg load) in the range of, for example, 50 to 50,000 Pa·s, or preferably 100 to 5,000 Pa·s.

In the formation of this resin layer, temperature conditions are set so that a curing agent or a foaming agent does not substantially decompose when the resin layer contains the curing agent or the foaming agent.

The resin layer thus formed has a thickness in the range of, for example, 0.02 to 10.0 μm, or preferably 0.03 to 6.0 μm. The thickness of the resin layer can also be set in the range of, for example, 0.2 to 3.0 mm, or preferably 0.5 to 2.5 mm.

In the present invention, the resin layer formed as described above has a storage modulus (G′) at 25° C. of, for example, 500 kPa or more, or preferably 1,500 kPa or more, and usually 200,000 kPa or less, or preferably 20,000 kPa or less.

The storage modulus at 25° C. of less than the above range may fail to sufficiently improve the reinforcement.

The resin layer in which the resin composition contains an ethylenic copolymer, a filler, and a tackifier has a Young's modulus at 23° C. (room temperature) of, for example, 1.0×10⁷ N/m², or preferably 5.0×10⁷N/m² and usually 1.0×10¹⁰ N/m² or less. The resin layer having a Young's modulus of less than 1.0×10⁷ N/m² may fail to obtain sufficient reinforcement.

The Young's modulus is calculated, for example, by cutting the resin layer formed by rolling into a 0.8-mm-thick sheet into pieces having 10 mm wide and 100 mm long, and measuring tensile strength in a distance between the chucks of 50 mm at a rate of 5 mm/min. with a universal testing machine.

The resin layer in which the resin composition contains a conjugated diene polymer and a tackifier has a storage modulus (G′) measured at 80° C. of, for example, 400 kPa or less, or preferably 350 kPa or less and usually 100 kPa or more.

When the resin layer has a storage modulus at 80° C. of less than the above range, the wind power generator blade and the resin layer may not be firmly stuck together.

The storage moduli (G′) at 25° C. and 80° C. are measured with a dynamic viscoelasticity measuring apparatus (measurement conditions: initial strain of 0.1%, heating rate of 5° C./min., and frequency of 1 Hz).

The restricting layer serves to restrain the resin layer to maintain the shape of the heated resin layer, and serves to provide tenacity for the resin layer to achieve improved strength. The restricting layer is in the form of a sheet and is formed of light weight and thin-film material to be stuck firmly and integrally with the heated resin layer. The materials that may be used for the restricting layer include, for example, glass cloth, metal sheet, synthetic resin nonwoven cloth, carbon fiber, and plastic film. These may be used alone or may be used by laminating a plurality of layers (materials).

The glass cloth is a cloth formed of glass fibers, and a known glass cloth can be used. A resin-impregnated glass cloth is included as the glass cloth. The resin-impregnated glass cloth is the above mentioned glass cloth impregnated with synthetic resin such as thermosetting resin or thermoplastic resin, and a known resin-impregnated glass cloth can be used. Examples of the thermosetting resin include epoxy resin, urethane resin, melamine resin, and phenol resin. Examples of the thermoplastic resin include vinyl acetate resin, ethylene vinyl acetate copolymer (EVA), vinyl chloride resin, and EVA-vinyl chloride resin copolymer. The thermosetting resin mentioned above and the thermoplastic resin mentioned above (e.g., melamine resin and vinyl acetate resin) may be combined.

Examples of the metal sheet include known metal sheets such as an aluminum sheet, a steel sheet, and a stainless sheet.

Examples of the synthetic resin nonwoven cloth include olefin resin nonwoven cloth and polyethylene terephthalate resin nonwoven cloth.

The carbon fiber is a cloth formed of fibers which mainly use carbon, and a known carbon fiber can be used.

Examples of the plastic film include polyester films such as polyethylene terephthalate (PET) film, polyethylene naphthalate (PEN) film, and polybutylene terephthalate (PBT) film; and polyolefin films such as polyethylene film and polypropylene film. Of these, PET film is preferable.

Of these materials, in terms of weight, degree of adhesion, strength, and cost, a glass cloth and/or a metal sheet is/are preferably used, or a glass cloth is more preferably used.

The restricting layer has a thickness of, for example, 0.05 to 2 mm, or preferably 0.1 to 1.0 mm.

The reinforcing sheet for wind power generator blades can be obtained by the above-mentioned method in which a resin layer and a restricting layer thereon are laminated.

The reinforcing sheet for wind power generator blades thus obtained has a thickness of, for example, 0.07 to 11.0 mm, or preferably 0.08 to 7.0 mm. Further, the thickness of the reinforcing sheet for wind power generator blades can be set in the range of, for example, 0.25 to 4.0 mm, or preferably 0.6 to 3.5 mm.

When the thickness of the reinforcing sheet for wind power generator blades exceeds the above range, it may become difficult to attain reduction in the weight of the reinforcing sheet for wind power generator blades, and production cost may increase. When the thickness of the reinforcing sheet for wind power generator blades is less than the above range, the reinforcing properties may not be sufficiently improved.

On the reinforcing sheet for wind power generator blades thus obtained, if desired, a release film (separator) can be adhesively bonded to a surface (a surface opposite to the rear surface where the restricting layer is laminated) of the resin layer until the sheet is actually used.

Examples of the release film include known release films such as synthetic resin films including polyethylene film, polypropylene film, and PET film.

The (resin layer of) the reinforcing sheet for wind power generator blades thus formed is adhesively bonded to a 2.0-mm-thick polypropylene plate, and when the reinforcing sheet is displaced by 1 mm after heating at 80° C. for 10 minutes, the flexural strength thereof is 3 N or more, preferably 3.5 N or more, more preferably 4 N or more, and usually 20 N or less, or preferably 10 N or less. The maximum flexural strength thereof is 30 N or more, preferably 35 N or more, or more preferably 40 N or more, and usually 200 N or less, or preferably 80 N or less.

The flexural strength at the time when the reinforcing sheet is displaced by 1 mm and the maximum flexural strength are measured in the following manner. A 2.0-mm-thick polypropylene plate reinforced with the reinforcing sheet for wind power generator blades is trimmed to have a length of 150 mm×a width of 25 mm to obtain a test piece, and the test piece was then subjected to a three-point bending test with a universal testing machine. The three-point bending test with a span of 100 mm was conducted by pressing the center (lengthwise and widthwise center) of the test piece from the polypropylene plate side at a rate of 50 mm/min. using an indenter having a diameter of 10 mm.

When the reinforcing sheet for wind power generator blades is adhesively bonded to the polypropylene plate, a resin layer is brought into contact with the polypropylene plate.

The flexural strength at the time when the reinforcing sheet is displaced by 1 mm is a flexural strength (strength) when the indenter is displaced by 1 mm after the pressing starts, and the maximum flexural strength is the maximum flexural strength (strength) for a period between the start of pressing and the moment at which the test piece is broken.

When the flexural strength at the time when the reinforcing sheet is displaced by 1 mm and the maximum flexural strength are within the above range, the wind power generator blade can be sufficiently reinforced.

The reinforcing sheet for wind power generator blades has an adhesive strength at room temperature (25° C.) against the polypropylene plate of, for example, 0.3 N/25 mm or more, or preferably 1.0 N/25 mm or more and usually 40 N/25 mm or less, or preferably 20 N/25 mm or less. The adhesive strength at room temperature (25° C.) was measured at a peel rate of 300 mm/min according to a 90 degree-peeling test.

When the adhesive strength at room temperature of the reinforcing sheet for wind power generator blades is within the above range, the resin layer slightly exhibits adhesiveness (slight tackiness), thereby allowing the reinforcing sheet for wind power generator blades to be reliably adhesively bonded to the wind power generator blade at room temperature before heating.

The reinforcing sheet for wind power generator blades has an adhesive strength after heating against the polypropylene plate of, for example, 0.5 N/25 mm or more, or preferably 0.8 N/25 mm or more and usually 200 N/25 mm or less, or preferably 20 N/25 mm or less. The adhesive strength after heating at 80° C. for 10 minutes was measured at a peel rate of 300 mm/min according to a 90 degree-peeling test.

The adhesive strength at room temperature and the adhesive strength after heating are measured by a 90-degree peeling test according to the description of “Testing methods of pressure-sensitive adhesive tapes and sheets” of JIS Z0237.

The reinforcing sheet for wind power generator blades of the present invention is used in order to reinforce the wind power generator blade for the wind power generator.

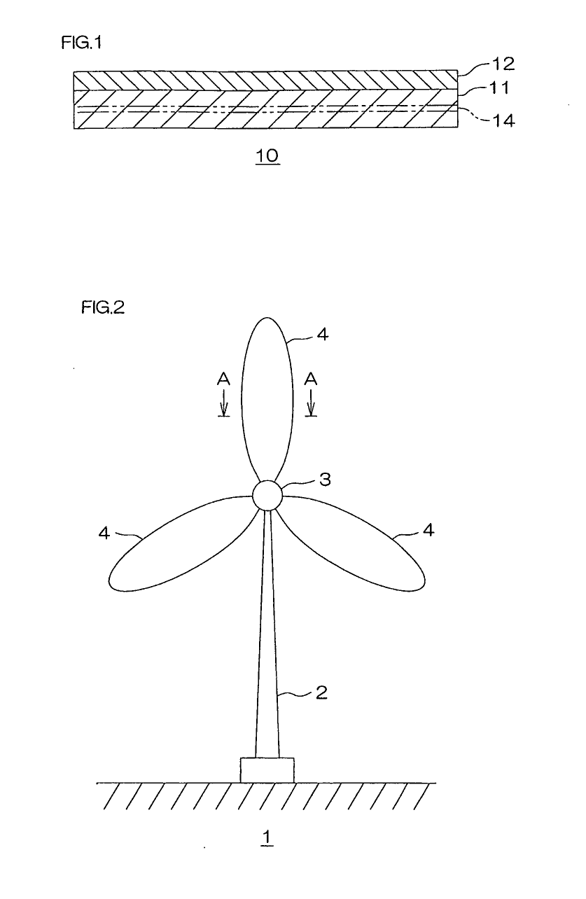

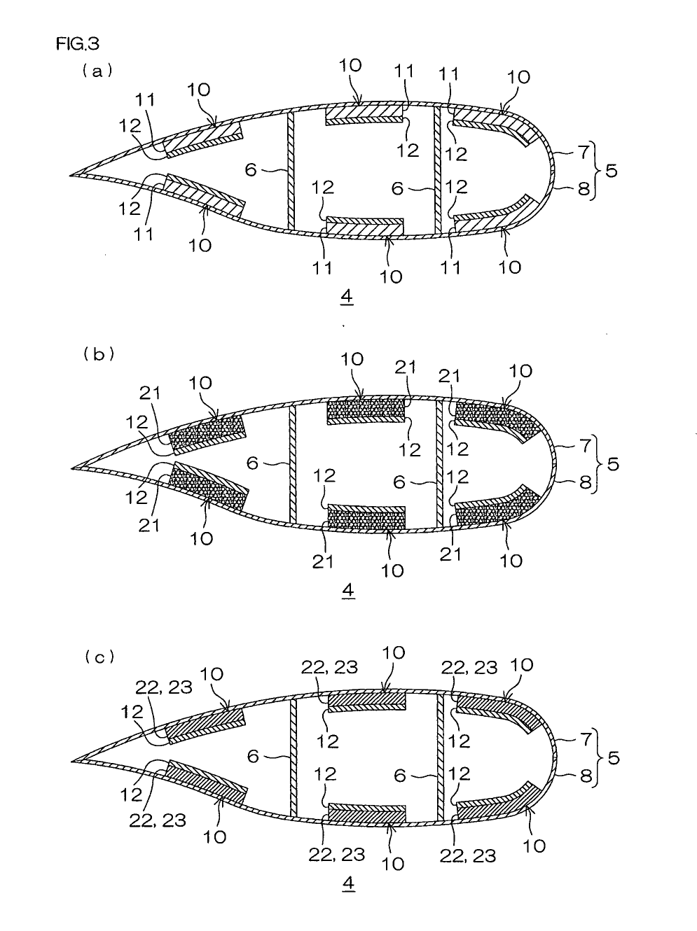

FIG. 1 is a sectional view showing one embodiment of a reinforcing sheet for wind power generator blades according to the present invention, FIG. 2 is a front view showing one embodiment of a wind power generator according to the present invention, and FIG. 3 is a sectional view showing one embodiment of a reinforcement structure of and a reinforcing method for a wind power generator blade according to the present invention, which taken along the line A-A of FIG. 2.

Next, one embodiment of the reinforcement structure of and the reinforcing method for the wind power generator blade of the present invention will be described with reference to FIGS. 1 to 3.

In FIG. 2, the wind power generator 1 includes a support 2 vertically arranged in a standing condition, a rotating shaft 3 provided on the upper end portion of the support 2, and a wind power generator blade 4 connected to the rotating shaft 3 and rotatably provided on the support 2.

The wind power generator blade 4 composes a plurality of vanes radially extended from the rotating shaft 3, and has a skin 5 and a girder 6 as shown in FIG. 3(a).

The skin 5 has a generally drop-shaped cross-section and is formed from a half-split structure including a first skin 7 and a second skin 8. The skin 5 is also formed in a hollow structure in the following manner: After a reinforcing sheet 10 for wind power generator blades and the girder 6 are disposed, both ends of the first skin 7 and the second skin 8 are abutted against each other in opposed relation, and these abutted skins are connected to form a hollow space (closed cross section).

The materials that may be used to form the skin 5 include, for example, carbon such as a carbon fiber; synthetic resin such as FRP (fiber reinforced plastics), polypropylene, polyvinyl chloride (PVC), polyester, and epoxy; metal such as aluminium alloy, magnesium alloy, titanium alloy, and ferrous steel; and wood such as balsa. Of these, FRP is preferable.

The girder 6 is arranged in the hollow space of the skin 5, coupled to the inner side surface of the first skin 7 and the inner side surface of the second skin 8, and is formed in the shape of a generally flat plate extending along the radial direction of the wind power generator blade 4. A plurality (two) of the girders 6 are arranged in spaced relation from each other in the rotation direction of the wind power generator blade 4, each arranged over the radial direction of the wind power generator blade 4.

The materials that may be used to form the girder 6 are the same materials as used to form the skin 5 mentioned above.

The reinforcing sheet 10 for wind power generator blades include a resin layer 11 and a restricting layer 12 laminated thereon, as shown in FIG. 1. In order to reinforce the wind power generator blade 4 with the reinforcing sheet 10 for wind power generator blades, as shown in FIG. 3(a), the resin layer 11 is adhesively bonded (temporarily attached or temporarily fixed) to the inner side surface of the first skin 7 and the inner side surface of the second skin 8 of the wind power generator blade 4.

In particular, first, the reinforcing sheet 10 for wind power generator blades are processed (cut) into a generally elongated rectangular shape so as to correspond to the adhesively bonded area to be described below.

Subsequently, the reinforcing sheet 10 for wind power generator blades is adhesively bonded to one end portion, the center portion, and the other end portion in the rotation direction divided by the girder 6 over the radial direction of the wind power generator blade 4.

The resin layer 11 is pressurized with a pressure of, for example, about 0.15 to 10 MPa when adhesively bonded.

Thereafter, the reinforcing sheet 10 for wind power generator blades adhesively bonded to the wind power generator blade 4 is heated.

In particular, when the resin layer 11 is formable, it is heated, for example, at 80 to 210° C. Due to such heating, the resin layer 11 is cured and foamed simultaneously. When the resin layer 11 further contains a crosslinking agent, it is cured, foamed, and crosslinked simultaneously. Due to the foaming of the resin layer 11, the reinforcing sheet 10 for wind power generator blades is firmly stuck to the skin 5.

A volume foaming ratio of the resin layer 11 after foaming (foamed layer 21, FIG. 3(b)) is in the range of, for example, 1.1 to 5.0 times, or preferably 1.5 to 3.5 times when foamed. A density of the foamed layer 21 (weight (g) of the foamed layer 21/volume (g/cm³) of the foamed layer 21) is in the range of, for example, 0.2 to 1.0 g/cm³, or preferably 0.3 to 0.8 g/cm³.

Then, as shown in FIG. 3(b), the resin layer 11 is cured and foamed to increase its strength and its thickness, thereby forming the foamed layer 21. Thus, the formation of the foamed layer 21 increases in thickness of the reinforcing sheet 10 for wind power generator blades, which provides improved rigidity, thereby improving the strength of the wind power generator blade 4 to which the reinforcing sheet 10 for wind power generator blades is adhesively bonded.

Besides, the foamed layer 21 is lightweight and can effectively suppress the increase in weight of the wind power generator blade 4. Further, after the foaming, the foamed layer 21 is restrained by the restricting layer 12, so that the shape of the foamed layer 21 is satisfactorily maintained and the foamed layer 21 is sandwiched between the skin 5 and the restricting layer 12, thereby providing further improved strength of the reinforcing sheet 10 for wind power generator blades.

Therefore, the wind power generator blade 4 reinforced with such reinforcing sheet 10 for wind power generator blades, although lightweight, can acquire sufficient rigidity, enabling an improvement in durability.

When the resin layer 11 is a curable resin layer which does not foam, it is heated, for example, at 80 to 160° C. Due to such heating, the resin layer 11 is cured. When the resin composition of the resin layer 11 further contains a crosslinking agent, the resin layer 11 is cured and crosslinked simultaneously. In the resin layer 11, the reinforcing sheet 10 for wind power generator blades has substantially the same thickness before and after curing, as shown in FIG. 3(c).

Then, the resin layer 11 is cured to increase its strength, thereby forming a cured layer 22. Thus, the reinforcing sheet 10 for wind power generator blades can improve the strength of the wind power generator blade 4 to which the reinforcing sheet 10 for wind power generator blades is adhesively bonded.

Besides, the cured layer 22 obtained by curing the resin layer 11 is lightweight and can effectively suppress the increase in weight of the wind power generator blade 4. Further, during (in the course of) curing and after curing, the resin layer 11 under curing (or the cured layer 22 after curing) is restrained by the restricting layer 12, so that the shape of the cured layer 22 is satisfactorily maintained and the restricting layer 12 can provide further improved strength of the reinforcing sheet 10 for wind power generator blades 4.

Further, when the resin layer 11 is a heat-sealable resin layer which does not foam, it is heated, for example, in the low temperature range described above, specifically, at 30 to 120° C.

More particularly, the heating temperature is usually a heat resistant temperature of the wind power generator blade 4 or lower, depending upon the type (melting point, softening temperature, etc.) of the thermoplastic resin, and when the resin composition contains an ethylenic copolymer as the thermoplastic resin, it is in the range of, for example, 60 to 120° C., or preferably 70 to 100° C. In addition, when the resin composition contains a conjugated diene polymer as the thermoplastic resin, the heating temperature is 80° C. or higher, preferably 90° C. or higher, or more preferably 100° C. or higher, and specifically, for example, 130° C. or lower, preferably 30 to 120° C., or more preferably 80 to 110° C.

When the heating temperature and the heating time are less than the above range, the wind power generator blade 4 and the restricting layer 12 cannot sufficiently be stuck, or the reinforcing properties of the wind power generator blade 4 may not be sufficiently improved during reinforcement. When the heating temperature and the heating time exceed the above range, the wind power generator blade 4 may deteriorate or fuse.

The heating time is in the range of, for example, for 0.5 to 20 minutes, or preferably, for 1 to 10 minutes.

Then, at the same time of the heating or after the heating, if desired, the reinforcing sheet 10 for wind power generator blades is pressurized to an extent that the resin composition does not flow out of the bonded portion, specifically at a pressure in the range of, for example, 0.15 to 10 MPa, using a press.

During the pressurization, at the same time of or after heating of the reinforcing sheet 10 for wind power generator blades and the skin 5, for example, the resin layer 11 is press-contacted toward the side of the skin 5, for example, at a rate of 5 to 500 mm/min. and a pressure of 0.05 to 0.5 MPa with a laminator roll, a hand roll (roller), or a spatula.

In the resin layer 11, as shown in FIGS. 3(a) and 3(c), the reinforcing sheet 10 for wind power generator blades has substantially the same thickness before and after heating and pressurization.

Then, the above heating causes the resin layer 11 to be formed into a heat-sealing layer 23. Further, the pressurization causes the heat-sealing layer 23 to be firmly stuck and heat-sealed (adhered) to the skin 5 and the restricting layer 12. Therefore, the heat sealing of the heat-sealing layer 23 can improve the strength of the skin 5.

In addition, since the resin layer 11 does not include any of a thermosetting resin, a curing agent, and a crosslinking agent, good storage stability of the resin layer 11 can be ensured and the skin 5 can be reinforced by heating and pressurizing the resin layer 11 at low temperature for a short period of time as described above. As a result, the reinforcing sheet 10 for wind power generator blades including the resin layer 11 is reliably produced, and while the use of the reinforcing sheet 10 for the wind power generator blade is ensured, the skin 5 can be reliably reinforced by heating and pressurizing the reinforcing sheet 10 for wind power generator blades at low temperature for a short period of time.

The resin layer 11 can also be heated (thermocompression bonded) together with the pressurization (adhesively bonding) shown in FIG. 3(a). Specifically, the reinforcing sheet 10 for wind power generator blades is preliminarily heated, and the reinforcing sheet 10 for wind power generator blades thus heated is then adhesively bonded to the wind power generator blade 4.

The thermocompression bonding conditions are as follows: The heating temperature is, for example, 80° C. or higher, preferably 90° C. or higher, or more preferably 100° C. or higher, and usually a heat resistant temperature of the wind power generator blade 4 or lower, specifically, 130° C. or lower, preferably 30 to 120° C., or more preferably 80 to 110° C.

After the heating and the pressurization (see FIG. 3(a)) described above, further heating can be performed as shown in FIG. 3(b) or 3(c).

Then, the above-mentioned reinforcing sheet 10 for wind power generator blades is adhesively bonded to the wind power generator blade 4, and the reinforcing sheet 10 for wind power generator blades is heated. This allows the resin layer 11 (the foamed layer 21, the cured layer 22 or the heat-sealing layer 23) after heating to be firmly stuck to the skin 5 of the wind power generator blade 4, thereby forming a reinforcing structure of the wind power generator blade 4 reinforced by the reinforcing sheet 10 for wind power generator blades.

In the reinforcing structure of and the reinforcing method for the wind power generator blade 4, the reinforcing sheet 10 for wind power generator blades is arranged in any point (or only a point that requires reinforcement) in the wind power generator blade 4, and easily and sufficiently reinforced, so that the rigidity of the wind power generator blade 4 can be easily and reliably secured, and the light weight of the wind power generator blade 4 can be secured.

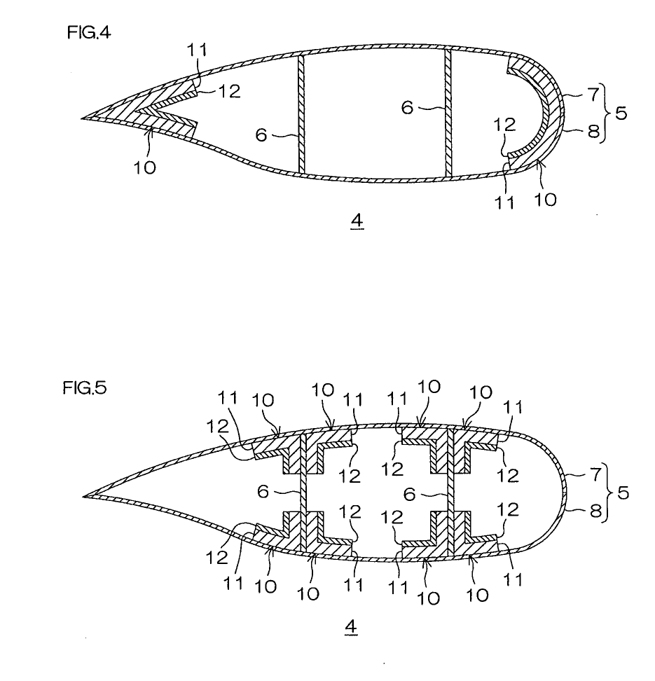

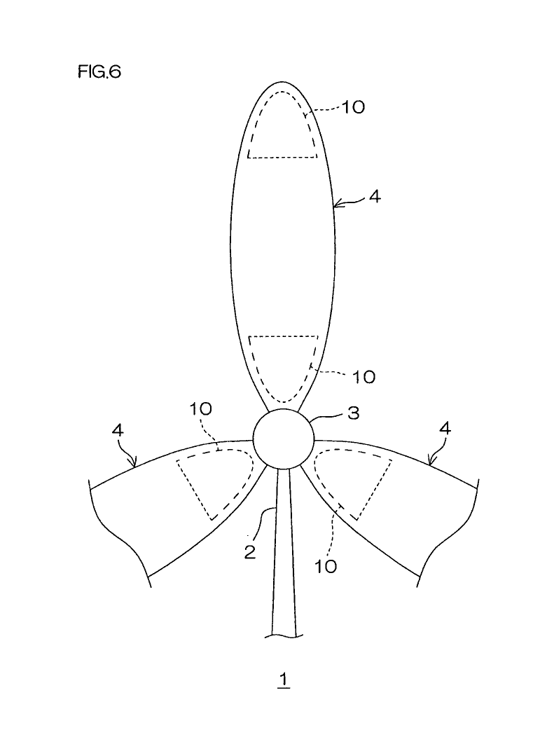

FIGS. 4 to 6 are sectional views of another embodiment of the reinforcement structure of the wind power generator blade according to the present invention. FIG. 4 is an embodiment in which a reinforcing sheet for wind power generator blades is adhesively bonded to both ends in a rotation direction of a wind power generator blade, FIG. 5 is an embodiment in which a reinforcing sheet for wind power generator blades is adhesively bonded to a connecting portion between a skin and a girder of a wind power generator blade, and FIG. 6 is an embodiment in which a reinforcing sheet for wind power generator blades is adhesively bonded to both radial ends of a wind power generator blade.

The same reference numerals are provided in each of the subsequent figures for members corresponding to each of those described above, and their detailed description is omitted.

In the above explanation of FIG. 3(a), the reinforcing sheet 10 for wind power generator blades is adhesively bonded to each of one end portion, a center portion, and the other end portion in the rotation direction of the skin 5. The adhering portions of the reinforcing sheet 10 for wind power generator blades are not limited thereto. For example, the adhering portions can be both ends of the wind power generator blade 4 in the rotation direction as shown in FIG. 4, the connecting portion between the skin 5 and the girder 6 of the wind power generator blade 4 as shown in FIG. 5, and further, both radial ends of the wind power generator blade 4 as shown in FIG. 6.

In FIG. 4, the reinforcing sheet 10 for wind power generator blades is continuously provided on the inner side surface of one end portion of the first skin 7 and that of one end portion of the second skin 8. The reinforcing sheet 10 for wind power generator blades is also adhesively bonded continuously to the inner side surface of the other end of the first skin 7 and that of the other end of the second skin 8.

In FIG. 5, the reinforcing sheet 10 for wind power generator blades is adhesively bonded in a generally L-shaped cross section to one end side surface of the girder 6 and the inner side surface of the first skin, and to the other end side surface of the girder 6 and the inner side surface of the second skin.

In the above explanation, the reinforcing sheet 10 for wind power generator blades is provided over the entire wind power generator blade 4 in the radial direction. However, for example, as shown in FIG. 6, it can also be provided in a part of the wind power generator blade 4 in the radial direction.

As indicated by dashed lines in FIG. 6, the reinforcing sheet 10 for wind power generator blades is adhesively bonded only to the outer end and the inner end of the wind power generator blade 4 in the radial direction.

In the explanation of the above-mentioned reinforcing sheet 10 for wind power generator blades in FIG. 1, the resin layer 11 is formed only from one sheet made of resin composition. However, for example, as indicated by phantom lines in FIG. 1, a nonwoven cloth 14 may be interposed partway in the thickness direction of the resin layer (preferably, a resin layer made of thermoplastic resin) 11.

The nonwoven cloth 14 include the same as the synthetic resin nonwoven cloth mentioned above. The nonwoven cloth 14 has a thickness of, for example, 0.01 to 0.3 mm.

The reinforcing sheet 10 for wind power generator blades is produced in the following processes. For example, according to the direct formation process, a first resin layer is laminated on a surface of the restricting layer 12, the nonwoven cloth 14 is laminated on a surface (opposite to the rear surface where the restricting layer 12 is laminated) of the first resin layer, and a second resin layer is subsequently laminated on a surface (opposite to the rear surface where the first resin layer is laminated) of the nonwoven cloth 14.

According to the transferring process, the nonwoven cloth 14 is sandwiched between the first resin layer and the second resin layer from both the front surface side and the rear surface side of the nonwoven cloth 14. Specifically, first, the first resin layer and the second resin layer are formed on the surfaces of two sheets of release film respectively, and the first resin layer is then transferred to the rear surface of the nonwoven cloth 14 while the second resin layer is transferred on the front surface of the nonwoven cloth 14.

The interposing of the nonwoven cloth 14 allows the resin layer 11 to be easily formed with a thick thickness corresponding to the strength of the wind power generator blade 4 desired to be reinforced.

While the illustrative embodiments of the present invention are provided in the above description, such is for illustrative purpose only and it is not to be construed restrictively. Modification and variation of the present invention that will be obvious to those skilled in the art is to be covered by the following claims.

What is claimed is:

1. A reinforcing sheet for wind power generator blades, comprising a resin layer and a restricting layer laminated on the resin layer.

2. The reinforcing sheet for wind power generator blades according to claim 1, wherein the resin layer is made of a thermosetting resin.

3. The reinforcing sheet for wind power generator blades according to claim 1, wherein the resin layer comprises an epoxy resin.

4. The reinforcing sheet for wind power generator blades according to claim 3, wherein the resin layer further comprises a synthetic rubber.

5. The reinforcing sheet for wind power generator blades according to claim 4, wherein the synthetic rubber comprises styrene synthetic rubber and/or acrylonitrile-butadiene rubber.

6. The reinforcing sheet for wind power generator blades according to claim 1, wherein the resin layer comprises a foaming agent and is formable.

7. The reinforcing sheet for wind power generator blades according to claim 1, wherein the resin layer is formed of a thermally adhering type adhesive composition.

8. The reinforcing sheet for wind power generator blades according to claim 7, wherein the adhesive composition comprises a polymer derived from monomers containing conjugated dienes.

9. The reinforcing sheet for wind power generator blades according to claim 7, wherein the adhesive composition further comprises a tackifier.

10. The reinforcing sheet for wind power generator blades according to claim 1, wherein the restricting layer is a glass cloth and/or a metal sheet.

11. A reinforcement structure of a wind power generator blade, wherein a reinforcing sheet for wind power generator blades comprising a resin layer and a restricting layer laminated on the resin layer is adhesively bonded to an inner side surface of a wind power generator blade having a hollow structure.

12. A wind power generator having a reinforcement structure of a wind power generator blade in which a reinforcing sheet for wind power generator blades comprising a resin layer and a restricting layer laminated on the resin layer is adhesively bonded to an inner side surface of a wind power generator blade having a hollow structure.

13. A method for reinforcing a wind power generator blade, comprising the steps of:
preparing a reinforcing sheet for wind power generator blades comprising a resin layer and a restricting layer laminated on the resin layer; and
adhesively bonding the reinforcing sheet for wind power generator blades to an inner side surface of a wind power generator blade having a hollow structure.

14. A method for reinforcing a wind power generator blade comprising the steps of:
adhesively bonding a reinforcing sheet for wind power generator blades comprising a resin layer and a restricting layer laminated on the resin layer, to an inner side surface of a wind power generator blade having a hollow structure; and
heating the reinforcing sheet for wind power generator blades.

15. A method for reinforcing a wind power generator blade comprising the steps of:
preliminarily heating a reinforcing sheet for wind power generator blades comprising a resin layer and a restricting layer laminated on the resin layer; and
adhesively bonding the heated reinforcing sheet for wind power generator blades to an inner side surface of a wind power generator blade having a hollow structure.
